(19) United States
(12) Patent Application Publication
(10) Pub. No.: US 2025/0216571 A1
(43) Pub. Date: Jul. 3, 2025

(54) RETRIEVING THE FUNDAMENTAL MODE OF GROUND-FORCE SIGNAL TO IMPROVE SEISMIC SURVEY

(71) Applicant: Saudi Arabian Oil Company, Dhahran (SA)

(72) Inventor: Yimin Sun, Den Haag (NL)

(21) Appl. No.: 18/402,050

(22) Filed: Jan. 2, 2024

(51) Int. Cl. G01V 1/34; E21B 41/00; E21B 49/00; G01V 1/143

(52) U.S. Cl. CPC G01V 1/345; E21B 41/00; E21B 49/00; G01V 1/143

(57) ABSTRACT

A computer-implemented method includes: accessing ground-force signal traces measured at each source location when applying a pilot sweep signal characterized by a sweeping instantaneous frequency that includes a fundamental component, wherein each ground-force signal trace comprises a fundamental mode signal component as well as at least one harmonic mode signal component; obtaining an analytic function representation for the pilot sweep signal and each ground-force signal trace, wherein the analytic function representation comprises a phase portion; establishing a matrix representation characteristic of the phase portion of the analytic function representation for the fundamental component in the ground-force signal, and wherein the matrix representation is size limited; retrieving, from the analytic function representation for each ground-force signal trace and after inverting the matrix representation, the fundamental mode signal component of the ground-force signal trace; and providing the retrieved fundamental mode signal component of each ground-force signal trace for subsequent data processing.

### TECHNICAL FIELD

This disclosure generally relates to seismic surveys using acoustic waves to probe subterranean regions.

### BACKGROUND

Field seismic data is often acquired during geophysical exploration in various industries, such as oil and gas, environmental studies, and civil engineering. The acquisition process generally involves deploying seismic sources and receivers in the field to measure the response of the subsurface to generated seismic wave. Seismic data reconstruction can be a major step during geophysical exploration that involves the restoration of seismic signals or images to enhance the quality of data acquired from seismic surveys.

### SUMMARY

In one aspect, the implementations provide a computer-implemented method that includes: accessing a plurality of seismic signal traces received at receivers in response to a Vibroseis truck, equipped with at least one base plate that is driven by a pilot sweep signal, generating a ground-force signal when the at least one base plate makes ground impact for launching an acoustic wave into a subterranean region of interest at a geophysical exploration site, wherein the pilot sweep signal is characterized by a sweeping instantaneous frequency including a fundamental frequency, and wherein the ground-force signal comprises a fundamental mode signal component as well as at least one harmonic mode signal component; obtaining, using a digital transform, an analytic function representation for the pilot sweep signal and the ground-force signal, wherein the analytic function representation comprises an amplitude portion and a phase portion; establishing a matrix representation characteristic of the phase portion of the analytic function representation for the fundamental frequency in the sweeping instantaneous frequency of the pilot sweep signal, and wherein the matrix representation is size limited by a sampling limit for the at least one harmonic mode signal component; retrieving, from the analytic function representation for the ground-force signal and after inverting the matrix representation, the fundamental mode signal component of the ground-force signal; and providing the retrieved fundamental mode signal component of the ground-force signal for subsequent data processing such that an image of the subterranean region of interest is formed and visualized to facilitate decision making at the geophysical exploration site.

Implementations may include one or more of the following features.

The matrix representation may include a Vandermonde matrix. The sampling limit for the at least one harmonic mode signal component may be a Nyquist limit. The matrix representation may be size limited by a window that meets the Nyquist limit. Said retrieving may include: applying the inverted matrix representation to a segment of the analytic function representation for the ground-force signal, wherein the segment is size limited by the window. Said retrieving further may include: extracting a real part of results of applying the inverted matrix representation to the segment of the analytic function representation for the ground-force signal. Each data trace may include a sequence of sample points providing multiple segments, each size limited by the window. A corresponding matrix representation may be established for each segment. Each corresponding matrix representation may be inverted for application to the corresponding segment so that the fundamental mode of signal component can be retrieved from the sequence of sample points. Said providing may include: cross-correlating the retrieved fundamental mode signal component of the ground-force signal with the seismic signal traces; and generating a set of seismic data based on results of said cross-correlating so that the image of the subterranean region of interest can be reconstructed using the set of seismic data in response to the acoustic wave. The method may further include: identifying, using a seismic interpretation workstation, a drilling target based, at least in part, on the image; and planning, using a well planning system, a wellbore trajectory guided by the drilling target.

In another aspect, the implementations provide a computer system comprising one or more hardware computer processors configured to perform operations of accessing a plurality of seismic signal traces received at receivers in response to a Vibroseis truck, equipped with at least one base plate that is driven by a pilot sweep signal, generating a ground-force signal when the base plate makes ground impact for launching an acoustic wave into a subterranean region of interest at a geophysical exploration site, wherein the pilot sweep signal is characterized by a sweeping instantaneous frequency including a fundamental frequency, and wherein the ground-force signal comprises a fundamental mode signal component as well as at least one harmonic mode signal component; obtaining, using a digital transform, an analytic function representation for the pilot sweep signal and the ground-force signal, wherein the analytic function representation comprises an amplitude portion and a phase portion; establishing a matrix representation characteristic of the phase portion of the analytic function representation for the fundamental frequency in the sweeping instantaneous frequency of the pilot sweep signal, and wherein the matrix representation is size limited by a sampling limit for the at least one harmonic mode signal component; retrieving, from the analytic function representation for the ground-force signal and after inverting the matrix representation, the fundamental mode signal component of the ground-force signal; and providing the retrieved fundamental mode signal component of the ground-force signal for subsequent data processing such that an image of the subterranean region of interest is formed and visualized to facilitate decision making at the geophysical exploration site.

Implementations may include one or more of the following features.

The matrix representation may include a Vandermonde matrix. The sampling limit for the at least one harmonic mode signal component may be a Nyquist limit. The matrix representation may be size limited by a window that meets the Nyquist limit. The retrieving step may include: applying the inverted matrix representation to a segment of the analytic function representation for the ground-force signal, wherein the segment is size limited by the window. The retrieving step further may include: extracting a real part of results of applying the inverted matrix representation to the segment of the analytic function representation for the ground-force signal. Each data trace may include a sequence of sample points providing multiple segments, each size limited by the window. A corresponding matrix representation may be established for each segment. Each corresponding matrix representation may be inverted for application to the corresponding segment so that the fundamental mode of signal component can be retrieved from the sequence of sample points. The providing step may include: cross-correlating the retrieved fundamental mode signal component of the ground-force signal with the seismic signal traces; and generating a set of seismic data based on results of said cross-correlating so that the image of the subterranean region of interest can be reconstructed using the set of seismic data in response to the acoustic wave. The operations may further include: identifying, using a seismic interpretation workstation, a drilling target based, at least in part, on the image; and planning, using a well planning system, a wellbore trajectory guided by the drilling target.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 depicts an example of a flowchart according to some implementations of the present disclosure.

FIG. 2 shows an example of a seismic acquisition system configured to acquiring field seismic data pertaining to a subterranean region of interest according to some implementations of the present disclosure.

FIG. 3 shows an example of another flow chart according to some implementations of the present disclosure.

FIG. 4 shows examples of simulated signals according to some implementations of the present disclosure.

FIG. 5 shows the respective Gabor domain plots for the examples of FIG. 4.

FIGS. 6A to 6D illustrates the comparison between the ground-truth fundamental mode signal and the results of retrieved fundamental mode signal according to some implementations of the present disclosure.

FIG. 7A illustrates field data ground force signal and the results of retrieved fundamental mode signal according to some implementations of the present disclosure and using other approaches.

FIG. 7B shows the respective Gabor domain plots for the signals of FIG. 7A.

FIG. 8 is a block diagram illustrating an example including both one or more field operations and one or more computational operations according to some implementations of the present disclosure.

FIG. 9 is another block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

During geophysical explorations, field seismic data can be acquired by deploying seismic sources and placing receivers. A typical geophysical exploration can involve a seismic survey to determine the layout of seismic sources and receiver arrays, taking into account the geological setting, potential hydrocarbon prospects, and the characteristics of the area. Seismic sources such as vibrators or explosives can generate controlled acoustic waves. For example, Vibroseis trucks equipped with large vibrating plates are often used for land surveys, while marine surveys might deploy air guns or water guns. Geophones or accelerometers, acting as seismic receivers, can be strategically placed across the survey area. The receivers are positioned in a grid pattern or along survey lines to capture the reflected seismic waves. The seismic source is activated, launching acoustic waves that travel through the subsurface. These waves interact with different rock layers, reflecting back towards the surface. Geophones record the arrival times and amplitudes of the reflected waves. The resulting data, known as seismic traces, represent the subsurface response at each receiver location.

In the context of acquiring field seismic data, Vibroseis trucks are one of the most commonly used excitation sources. Although a Vibroseis truck is driven by a designed pilot sweep signal, due to the mechanic nature of the vibrator and the complex coupling effect between the base plate of the truck and the ground, the excited real ground-force signal is composed of both the fundamental mode, somewhat similar to the pilot sweep, and its high-order harmonics. For additional context, the designed pilot sweep signal is also known as the drive signal. The ground-force signal refers to the force or pressure exerted on the ground by, for example, the vibrating base plate of the Vibroseis truck driven by the drive signal, for example, during a seismic survey. To measure the ground-force signals, force sensors or accelerometers may be deployed directly on or near the source. Here, the ground-force signals can produce acoustic waves that propagate through the subsurface. These acoustic waves then interact with the geological formations, and the resulting signals are recorded by seismic receivers (e.g., geophones or accelerometers) to provide seismic data that reveal information about the subsurface structure.

In this context, it is actually the fundamental mode of ground-force signal that is needed for cross-correlating with raw measurements (e.g., seismic data acquired by seismic receivers) to obtain the seismic data for subsequent processing. However, robustly and efficiently retrieving the fundamental mode from ground-force signals is not trivial, given the time-varying nature of the fundamental mode signal and the voluminous quantity of raw measurements (e.g., petabytes) taken at the receivers in the field. The retrieval process, in most cases, engages a matrix inversion process which tends to be computationally expensive and intensive, in terms of memory usage and CPU time.

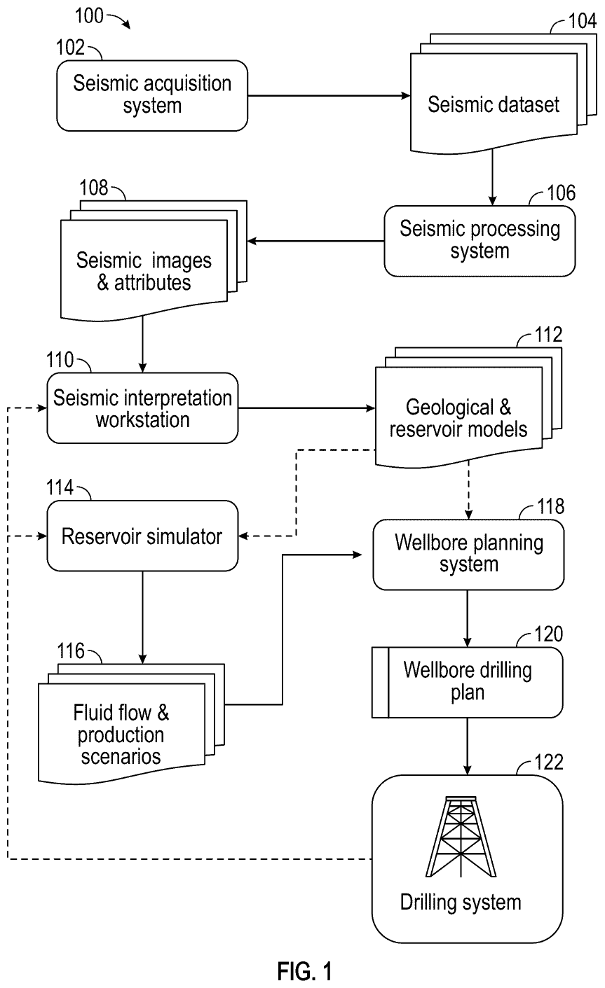

To address the technical challenge, the present disclosure provides a light-weight solution, e.g., in the analytic-signal domain. Specifically, the present disclosure is directed to system and method to analyze ground-force signal in response to excitation sources such as a Vibroseis truck driven by a designed pilot sweep signal. In exemplary implementations, the retrieval of the fundamental mode of ground-force signal is framed as inverting a matrix data structure, such as a well-posed Vandermonde matrix, based on a mathematical model. Because the Vandermonde matrix only needs to cover the maximum harmonic order within the limits of the Nyquist-frequency sample criterion, the Vandermonde matrix is sufficiently small to allow for compact and efficient computations including, for example, matrix inversions. The exemplary implementations may then use the retrieved fundamental mode signal for cross-correlating with raw measurements to obtain seismic data for follow-up processing. Compared with raw measurements taken from the receivers in the field, the seismic data obtained using implementations of the present disclosure has significantly improved data quality, which can be leveraged to by following-up processing steps (e.g., beamforming and imaging steps) to obtain more reliable imaging results to facilitate data interpretation and decision making at a geophysical exploration site. In other words, the implementations of the present disclosure are directed to improvement in computer-related technology to efficiently and accurately generate field seismic data with sufficient fidelity for subsequent data processing so that visualization results can be generated expediently, thereby allowing for interpretation of subterranean features at the geophysical exploration site with higher confidence. Details of the implementations are provided below in association with FIGS. 1-5, 6A-6B, 7A-7D, and 8-9.

FIG. 1 depicts a flowchart (100) in accordance with some implementations of the present disclosure. FIG. 1 illustrates the steps of acquiring remote sensing data, processing the remote sensing data, forming a geological model, optionally simulating the flow of fluids, including hydrocarbons, though the geological model, the planning of wellbores including their surface position, trajectories, and targets, and the drilling of those wellbores. Although the steps in flowchart (100) are shown in sequential order, it will be apparent to one of ordinary skill in the art, that some steps may be conducted in parallel, or in a different order than shown, or may be omitted without departing form the scope of the subject matter.

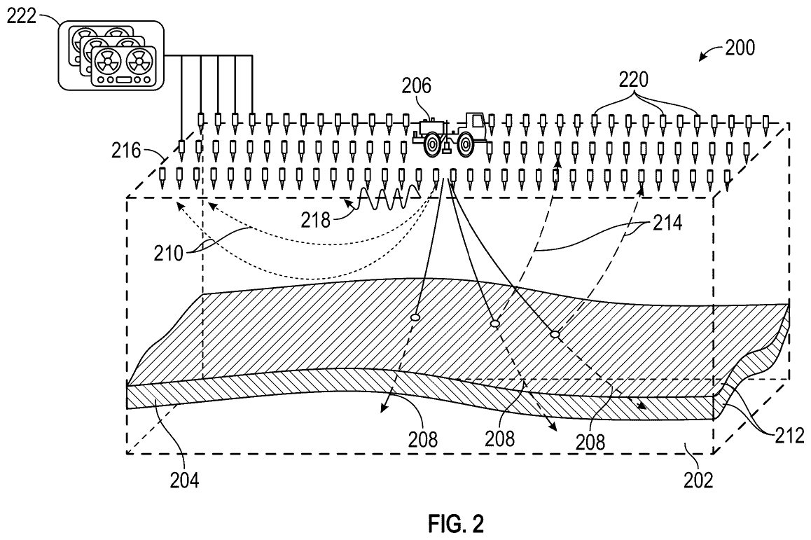

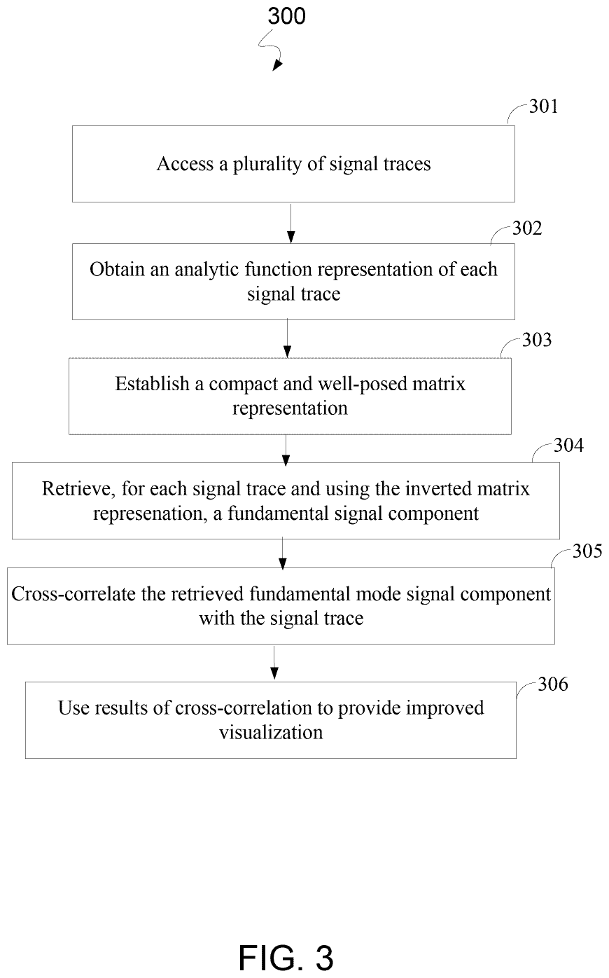

For example, flowchart (100) may begin with the use of a seismic acquisition system (102) to acquire a seismic dataset (104) over a subterranean region of interest. The seismic acquisition system (102) will be described in more detail in the context of FIG. 2, and an example of generating a seismic dataset from raw measurements is shown in FIG. 3. Other remote sensing datasets may also be collected at this stage to characterize the subterranean region of interest. For example, resistivity, transient electromagnetic, and/or gravitation surveys may be collected.

The seismic dataset contains seismic recordings that are influenced by the geological structure of the subterranean region. However, seismic datasets (104) also contain a wide variety of noise and distortion and does not in its unprocessed “raw” form display significant useful information about the subterranean region. Consequently, seismic datasets (104) are typically processed to remove or attenuate noise and to correctly locate geological boundaries that reflect seismic waves (“seismic reflectors” in two-dimensional (“2D”) or three-dimensional (“3D”) space within the subterranean region.

To determine earth structure, including the presence of hydrocarbons, the seismic data set must be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Each of these steps may be accompanied by one or more quality control steps. Critical steps in processing seismic data include beam forming and seismic migration. Seismic migration is a process by which seismic events are re-located in either space or time to their true subsurface positions.

It will be appreciated by one of ordinary skill in the art that seismic datasets (104) are extremely large, typically occupying hundreds of Terabytes or more than a Petabyte in size, (corresponding to between 10 trillion (1013) and 100 trillion (1014) data samples) and cannot be manipulated or “processed” without the assistance of a purpose configured seismic processing system (106).

A seismic processing system (106) may be composed of a computer system, such as the computer system shown in FIG. 11. However, a seismic processing system will typically be configured with appropriate seismic processing software and augmented with a number of purpose specific elements, such as high capacity tape drives or hard drives connected through high-speed buses to computer processing units (“CPUs”). Further the CPUs of a seismic processing system will typically be connected to a plurality of graphical processing units (“GPUs”) that perform many of the computationally intensive operations on the seismic dataset (104), banks of high-speed tape, or hard-drive, readers to read the data from storage, high-speed tape or hard-drive writers to output final or intermediate results, and high-speed communication buses to connect these elements.

The result of processing a seismic dataset (104) with a seismic processing system (106) is a seismic image (108). The seismic image is a 2D or 3D image of the points within the subsurface that generate a distinctive seismic response. For example, the seismic image (108) may display the points at which seismic energy is reflected, or scattered, within the subsurface. Other seismic characteristic or “attributes” of the subsurface may be displayed as a seismic image (108). For example, the strength of conversion of energy from one type of seismic wave to another, or the strength of absorption of seismic energy, or the velocity of seismic propagation may be displayed as a function of subsurface position in the seismic image (108). The examples of seismic attributes given above are purely illustrative, and a person of ordinary skill in the art will appreciate that anyone of dozens of other attributes may be displayed as a seismic image (108) and the examples described should not be interpreted as limiting the scope of the inventive subject matter.

The seismic image (108) is an image, typically composed of pixels of varying intensity, and is not itself a model of the geological structure of the subterranean region to which it pertains. To determine the geological structure corresponding to, or that produced, the seismic image (108) the seismic image (108) is typically “interpreted” using a seismic interpretation workstation (110).

A seismic interpretation system (110) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs Additional data may be used within the seismic interpretation workstation (110) to facilitate the interpretation of the seismic dataset. Such additional data may include well logs acquired from previously drilled wells and acquired either while-drilling or via wireline conveyed well logging tools after drilling. Such data may also include non-seismic remote sensing datasets such as resistivity, transient electromagnetic, and/or gravitational surveys.

Interpreters may pick and interpret key geological horizons within seismic data to identify stratigraphic layers, boundaries, and structural features. Horizon interpretation tools and workflows allow for the accurate extraction of geological information from seismic volumes. For example, a seismic interpretation system (110) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation system (110) to build 3D geological models by integrating seismic data with well-log data, geological knowledge, and other geophysical information. These models help in estimating reservoir properties, optimizing well locations, and predicting hydrocarbon distribution. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (110) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

The seismic interpretation system (110) can be instrumental for geoscientists involved in exploration and production activities, helping them make informed decisions about drilling locations, optimize production strategies, and understand complex subsurface geological structures. The seismic interpretation system (110) may be a specialized computer system used by geoscientists and seismic interpreters for analyzing and interpreting seismic data.

Seismic interpretation involves intensive tasks like data visualization, horizon picking, attribute analysis, and 3D modeling. A high-performance seismic interpretation system (110) with a powerful processor, ample memory, and a high-resolution display is essential to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (110) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access this data efficiently. The seismic interpretation system (110) often requires network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. A seismic interpretation workstation (110) may be augmented with purpose specific peripherals such as high capability display devices that may include immersive or virtual reality devices, such as virtual-reality headsets or immersive “caves”. Additionally, color-calibrated and high-accuracy input devices enhance the precision of interpretation tasks like picking horizons or drawing geological features. The seismic interpretation system (110) should have backup solutions in place to protect valuable data from loss or damage. Automated backup systems, external storage devices, or network-attached storage (NAS) can be utilized to ensure data safety. In some cases, seismic interpreters may need remote access to the seismic interpretation system (110) or collaborate with colleagues remotely. Setting up remote access capabilities, such as Virtual Private Networks (VPNs) or remote desktop solutions, allows interpreters to work from different locations and share their work effectively. The seismic interpretation system (110) may be customized to meet the needs of interpreters and the specific requirements of projects. The hardware specifications may vary based on factors like the complexity of interpretations, the size of datasets, and the software tools utilized.

The result of interpreting the seismic image may be a geological model (112) of the subsurface, including reservoir models of hydrocarbon reservoirs within the subterranean region of interest. Geological models (112) may include the locations of geological interfaces, such as the boundary between volumes (“formations”) containing different rock types (“facies”), and faults and fractures. Geological models may also include descriptions of the characteristics of the different facies including characteristics such as porosity and permeability, and the relative amounts of different fluids, such as gas, oil and brine, within the pores in each facies.

In some embodiments, the geological models (112) may be used directly to create a wellbore drilling plan (120) using a wellbore planning system (118). Such a wellbore drilling plan (120) may contain drilling targets, often geological regions expected to contain hydrocarbons. The wellbore planning system (118) may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system (122). Similarly, the wellbore drilling plan (120) may include a determination of wellbore caliper, and casing points.

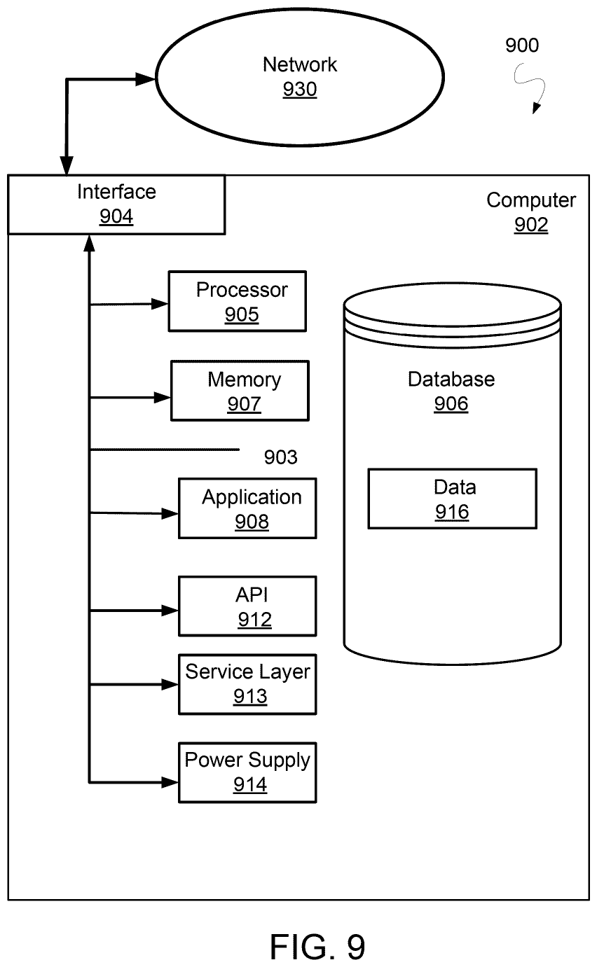

The wellbore planning system (118) may include dedicated software stored on a memory of a computer system, such as the computer system shown in FIG. 9. The wellbore plan (120) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

The wellbore path may include a starting surface location of the wellbore, or a subsurface location within an existing wellbore, from which the wellbore may be drilled. The wellbore path may further include a terminal location that may intersect with the previously located hydrocarbon reservoir, such as hydrocarbon reservoir (204) shown in FIG. 2. The wellbore path may further still include wellbore geometry information such as wellbore diameter and inclination angle and when each of these change along the depth of the wellbore. If casing is used, the wellbore plan (120) may include casing type or casing depths. Furthermore, the wellbore plan (120) may consider other engineering constraints such as the maximum wellbore curvature (“dog-log”) that a drill string of a drilling system may tolerate and the maximum torque and drag values that the drilling system may provide. The wellbore plan (120) may further define associated drilling parameters, such as the planned depths at which drilling may be paused and casing will be inserted to support the wellbore to prevent formation fluids entering the wellbore and the drilling mud weights (densities) and types that may be used during drilling of the wellbore.

In some implementations, the geological model (112) may be input to a reservoir simulator (114). A reservoir simulator (114) includes functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator (114) may be used to predict changes in fluid flow, including fluid flow into wells penetrating the reservoir as a result of planned well drilling, and/or fluid injection and extraction. For example, the reservoir simulator may be used to predict fluid-flow and production scenarios (116) including changes in hydrocarbon production rate that would result from the injection of water into the reservoir from wells around the reservoirs periphery.

The reservoir simulator (114) may use a geological model or reservoir model (112) that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected from well logs acquired in well penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators can solve a set of mathematical governing equations that represent the physical laws that govern fluid flow in porous, permeable media. For example, the flow of a single-phase slightly compressible oil with a constant viscosity and compressibility pursuant to Darcy's law, the continuity condition and the state equation.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

The fluid flow and production scenarios (116) predicted by the reservoir simulator (114) may then be used by the wellbore planning system (118) to determine the wellbore drilling plan (120).

While a wellbore drilling plan (120) is formed using the best available information at the time at which it is formed, additional information may become available when drilling the wellbore specified by the plan. For example, well logs providing new information about the reservoir structure and characteristic may be acquired while drilling (so-called “logging-while-drilling” (LWD) logs or during drilling pauses in, or at the completion of drilling of, a wellbore specified by the drilling plan (120). These well logs acquired during pauses or at the cessation of drilling may be acquired using wireline or coiled tubing conveyed logging tools. However acquired, these new wells may be used to update geological and reservoir models (112) with the aid of a seismic interpretation workstation or to directly update the reservoir simulation performed by the reservoir simulator (114).

FIG. 2 shows a seismic acquisition system (200) configured to acquiring a seismic dataset pertaining to a subterranean region of interest (202). The subterranean region of interest (202) may or may not contain a hydrocarbon reservoir (204). The purpose of the seismic survey may be to determine whether or not a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (206), when activated, generates radiated seismic waves, such as those whose paths are indicated by the rays (208). The radiated seismic waves may be bent (“refracted”) by variations in the speed of seismic wave propagation within the subterranean region (202) and return to the surface of the earth (216) as refracted seismic waves (210). Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs.

At the surface, the refracted seismic waves (210) and reflected seismic waves (214) may be detected by seismic receivers (220). On land a seismic receiver (220) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receiver (220) may be positioned at a seismic receiver location that may be denoted (xᵣ, yᵣ) where x and y represent orthogonal axes, such as North-South and East-West, on the surface of the earth (216) above the subterranean region of interest (202). Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). In some case, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey (218). Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other cases, such as marine seismic acquisition (not shown) the seismic source may be towed a short distance behind a seismic vessel and strings of receivers attached to multiple cables (“streamers”) are towed behind the seismic sources. Thus, a seismic dataset, the aggregate of all the seismic data acquired by the seismic survey, may be represented as a five-dimensional volume (four space dimensions and one time dimension) with coordinate axes (xx, yᵣ, yₛ, yₛ, t).

The implementations can analyze ground-force signal in response to excitation sources such as a Vibroseis truck driven by a designed pilot sweep signal. In exemplary implementations, the retrieval of the fundamental mode of ground-force signal is framed as inverting a matrix data structure, e.g., a well-posed Vandermonde matrix, based on a mathematical model. Because the Vandermonde matrix used in various implementations only needs to cover the maximum harmonic order within the limits of the Nyquist-frequency sample criterion (also known as the Nyquist limit), the Vandermonde matrix is sufficiently small to allow for compact and efficient computations including, for example, matrix inversions. The exemplary implementations may then use the fundamental mode for cross-correlating with raw measurements to obtain seismic data.

FIG. 3 shows an example of a flow chart 300 according to some implementations of the present disclosure. In step 301, the process may access an input set of measurement data including a plurality of signal traces received at receivers placed, e.g., on a grid in the field of a geophysical exploration site. As explained in more detail above in association with FIG. 2, a Vibroseis truck, driven by a pilot sweep signal, can launch an acoustic wave into a subterranean region of interest at the geophysical exploration site. The pilot sweep signal may be characterized by a sweeping instantaneous frequency including a fundamental component. Each signal trace comprises a fundamental mode signal component as well as at least one higher order harmonic signal component.

In step 302, the process may obtain, using a digital transform (e.g, a Hilbert transform), an analytic function representation for the pilot sweep signal and each signal trace from the input set of measurement data. The analytic function representation may include an amplitude portion and a phase portion.

Without loss of generality, the present disclosure will use q(t) to connotate a pilot sweep signal that drives a Vibroseis truck, which may be mathematically described as:

$$q ( t ) = a ( t ) \cdot sin [ 2 πθ ( t ) ] , \qquad ( 1 )$$

where a(t) is an amplitude function, and θ(t) is a time-dependent phase term. The analytic signal of q(t) can be expressed as:

$$z ( t ) = q ( t ) + \frac{j}{π} {\int }_{- ∞}^{∞} \frac{q ( τ )}{t - τ} d τ = m ( t ) \cdot {e}^{j ϕ ( f )} . \qquad ( 2 )$$

The instantaneous frequency, which is the Vibroseis sweep frequency, is defined as:

$${f}^{inst} ( t ) = \frac{d φ ( t )}{dt} . \qquad ( 3 )$$

Based upon Equation (3), the phase of the fundamental mode of ground-force signal can be:

$${φ}_{1} ( t ) = \int {f}^{inst} ( t ) dt + {C}_{1} = φ ( t ) + {C}_{1} , \qquad ( 4 )$$

and the N^{th}-order harmonic possesses a phase term:

$${φ}_{N} ( t ) = N \int {f}^{inst} ( t ) dt + {C}_{N} = N φ ( t ) + {C}_{N} , \qquad ( 5 )$$

where C₁ or C_{N} is a constant initial phase for the mode of interest. The N^{th}-order harmonic of ground-force signal thus can be written as:

$${q}_{N} ( t ) = Re \{ {m}_{N} ( t ) {e}^{i [ N \cdot φ ( f ) + {C}_{N} ]} \} , \qquad ( 6 )$$

where Re{ } represents taking the real part of the input term, and m_{N}(t) is the amplitude function of the N^{th}-order harmonic.

In step 303, the process may establish a matrix representation characteristic of the phase portion of the analytic function representation for the fundamental mode in the pilot sweep signal, and wherein the matrix representation is size limited by a sampling limit for the at least one higher order harmonic component.

In step 304, the process may retrieve, from the analytic function representation for each signal trace and after inverting the matrix representation, the fundamental mode signal component of the signal trace.

In more detail, by assuming the measured ground-force signal g(t) is composed completely by the fundamental mode u₁(t) and its corresponding higher-order harmonics uᵢ(t) where i=2, 3, 4 . . . , and this mathematical model can then be written as:

$$g ( t ) = {\sum }_{n = 1}^{N} {u}_{n} ( t ) . \qquad ( 7 )$$

By building the analytic signals of both sides of Equation (7), the following expression may be obtained:

$$G ( t ) {e}^{i φ ( t )} = {\sum }_{n = 1}^{N} {U}_{n} ( t ) {e}^{i {θ}_{n} ( t )} , \qquad ( 8 )$$

where G(t) and Uₙ(t) account for the amplitude function of the ground-force signal and the n^{th}-order harmonic, and φ(t) and θₙ(t) are the phase function. Note that in addition to the amplitude information of uₙ(t) in the analytic-signal domain, Uₙ(t) also absorbs the initial phase influence of n^{th}-order harmonic so that θₙ(t)=nθ₁(t).

At a time moment t=tₘ, Equation (8) can be written as:

$$G ( {t}_{m} ) {e}^{i φ ( t )} = {\sum }_{n = 1}^{N} {U}_{n} ( {t}_{m} ) {e}^{in {θ}_{1} ( {t}_{m} )} . \qquad ( 9 )$$

Applying a mathematical manipulation to Equation (9), the following expression can be obtained:

$$G ( {t}_{m} ) {e}^{i [ φ ( {t}_{m} ) - {θ}_{1} ( {t}_{m} ) ]} = {\sum }_{n = 1}^{N} {U}_{n} ( {t}_{m} ) {e}^{i ( n - 1 ) {θ}_{1} ( {t}_{m} )} . \qquad ( 10 )$$

While Uₙ(t) can be a time-variant function in principle, within a small time window [tₘ, tₘ₊ₚ], Uₙ(t) can be treated as time-invariant. With this approximation, in the time window [tₘ, tₘ₊ₚ], below matrix equation can be established:

$$Ax = b , \qquad ( 11 )$$

$$A = ( \begin{matrix}1 & {e}^{i {θ}_{1} ( {t}_{m} )} & & {e}^{i ( p - 2 ) {θ}_{1} ( {t}_{m} )} & & {e}^{i ( p - 1 ) {θ}_{1} ( {t}_{m} )} \\ 1 & {e}^{i {θ}_{1} ( {t}_{m + 1} )} & ⋯ & {e}^{i ( p - 2 ) {θ}_{1} ( {t}_{m + 1} )} & & {e}^{i ( p - 1 ) {θ}_{1} ( {t}_{m + 1} )} \\ & ⋮ & ⋮ & & ⋮ & \\ 1 & {e}^{i {θ}_{1} ( {t}_{m + p - 1} )} & ⋯ & {e}^{i ( p - 2 ) {θ}_{1} ( {t}_{m + p - 1} )} & & {e}^{i ( p - 1 ) {θ}_{1} ( {t}_{m + p - 1} )} \\ 1 & {e}^{i {θ}_{1} ( {t}_{m + p} )} & & {e}^{i ( p - 2 ) {θ}_{1} ( {t}_{m + p} )} & & {e}^{i ( p - 1 ) {θ}_{1} ( {t}_{m + p} )}\end{matrix} ) . \qquad ( 12 )$$

$$x = ( \begin{matrix}{U}_{m} \\ {U}_{m + 1} \\ ⋮ \\ {U}_{m + p - 1} \\ {U}_{m + p}\end{matrix} ) , \qquad ( 13 )$$

$$b = ( \begin{matrix}G ( {t}_{m} ) {e}^{i [ φ ( {t}_{m} ) - {θ}_{1} ( {t}_{m} ) ]} \\ G ( {t}_{m + 1} ) {e}^{i [ φ ( {t}_{m + 1} ) - {θ}_{1} ( {t}_{m + 1} ) ]} \\ ⋮ \\ G ( {t}_{m + p - 1} ) {e}^{i [ φ ( {t}_{m + p - 1} ) - {θ}_{1} ( {t}_{m + p - 1} ) ]} \\ G ( {t}_{m + p} ) {e}^{i [ φ ( {t}_{m + p} ) - {θ}_{1} ( {t}_{m + p} ) ]}\end{matrix} ) , \qquad ( 14 )$$

where the matrix A is a Vandermonde matrix.

In order for A to be mathematically invertible, in the most general case for the use case example, the following condition needs to be met:

$${θ}_{1} ( {t}_{m + p} ) - {θ}_{1} ( {t}_{m} ) < 2 π . \qquad ( 15 )$$

From the physics perspective, this means that within this small time window, the average instantaneous frequency should satisfy:

$$\overline{{f}^{inst}} \cdot p \cdot Δ t < 1. \qquad ( 16 )$$

Due to the Nyquist-frequency requirement, if the highest harmonic frequency, N·f̅^̅{̅i̅n̅s̅t̅}̅, is still not aliased, then it should satisfy the relationship:

$$\overline{{f}^{inst}} N Δ t < \frac{1}{2} , \qquad ( 17 )$$

where N is the maximum harmonic order. Based upon the above analysis, as long as we choose the time window parameter p to equal N, our Vandermonde matrix represented by Equation (11) is guaranteed to be mathematically invertible.

Once Um in Equation (13) is retrieved, the fundamental mode of ground-force signal at the time moment t=tₘ can be calculated as:

$${q}_{1} ( {t}_{m} ) = Re \{ {U}_{m} {e}^{i {θ}_{1} ( {t}_{m} )} \} . \qquad ( 18 )$$

In step 305, the process may cross-correlate the retrieved fundamental mode signal component with the signal trace.

In step 306, the process may generate a set of seismic data using results of cross-correlating, and then provide the set of seismic data for subsequent data processing that yields improved visualization of the subterranean region of interest at the geophysical exploration site, as explained above in association with FIG. 2.

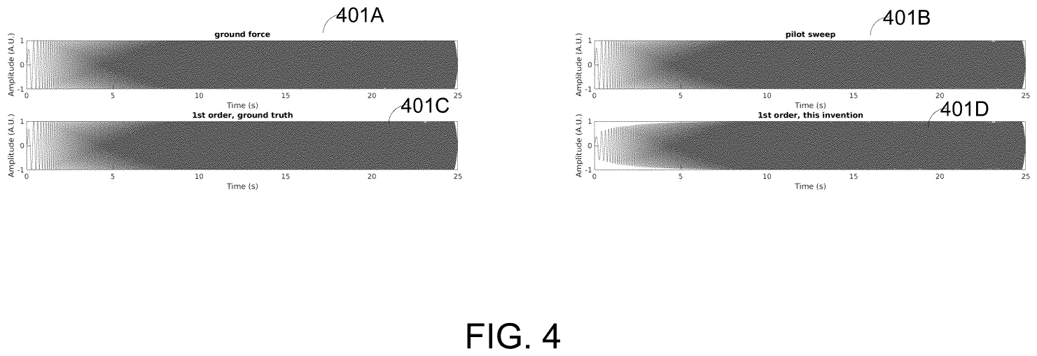

The implementations provide the retrieval of the fundamental mode of ground-force signal. The retrieval is framed as inverting a well-posed Vandermonde matrix, which is compact in size because the Vandermonde matrix only needs to cover the maximum harmonic component under limits of the Nyquist-frequency condition. The size and the regularized matrix can improve computational efficiency and reduce memory consumption when generating the seismic data set for subsequent data processing. The efficacy of the implementations, in terms of accuracy and scalability, are demonstrated below in association with FIGS. 4-5, 6A-6D, and 7A-7B. Generally speaking, considering the fundamental mode and its harmonics up to the 5th order is enough to account for components in a ground-force signal, so a 5 by 5 Vandermonde matrix is usually enough to invert for the fundamental mode in the ground-force signal. The size of such a Vandermonde matrix is ˜1000 times smaller than the matrix used in the Gabor-domain inversion methods, implying ˜1000 times improvement in the computation efficiency.

FIG. 4 demonstrates examples of simulated signals according to some implementations of the present disclosure. Plot 401A shows the input synthetic ground-force signal generated by a simulation in which a Vibroseis truck is used as a vibration source for launching an acoustic wave. Plot 401B shows the pilot sweep signal used by the Vibroseis truck in the simulation for generating the synthetic ground-force signal. Plot 401C shows the ground-truth of the fundamental mode signal in this synthetic ground-force signal generated by the simulation. Plot 401D shows the fundamental mode signal retrieved using implementations of the present disclosure.

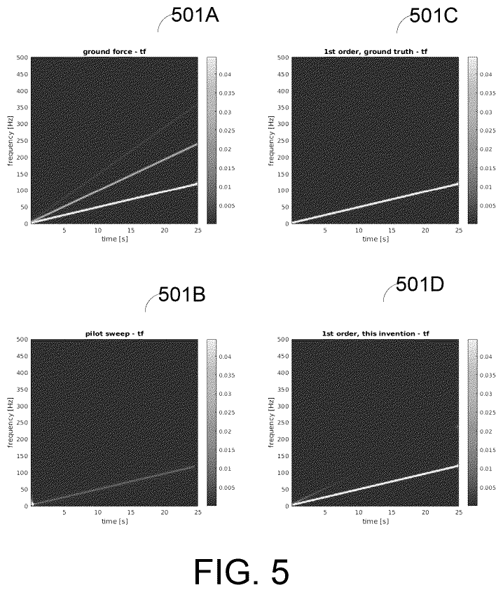

FIG. 5 shows the respective Gabor domain plots for the examples of FIG. 4. Specifically, plot 501A shows a Gabor domain plot of the synthetic ground-force signal of plot 401A. The Gabor domain covers a horizontal time axis and a vertical frequency axis. As shown, the synthetic ground-force signal has fundamental signal component and higher order harmonic components, all of which exhibit a swept frequency span. Plot 501B shows the Gabor domain plot of the pilot sweep signal of plot 401B. Plot 501C shows the Gabor domain plot of the ground-truth of the fundamental mode signal of plot 401C. Plot 501D shows the Gabor domain plot of the fundamental mode signal from plot 401D, as retrieved using implementations of the present disclosure.

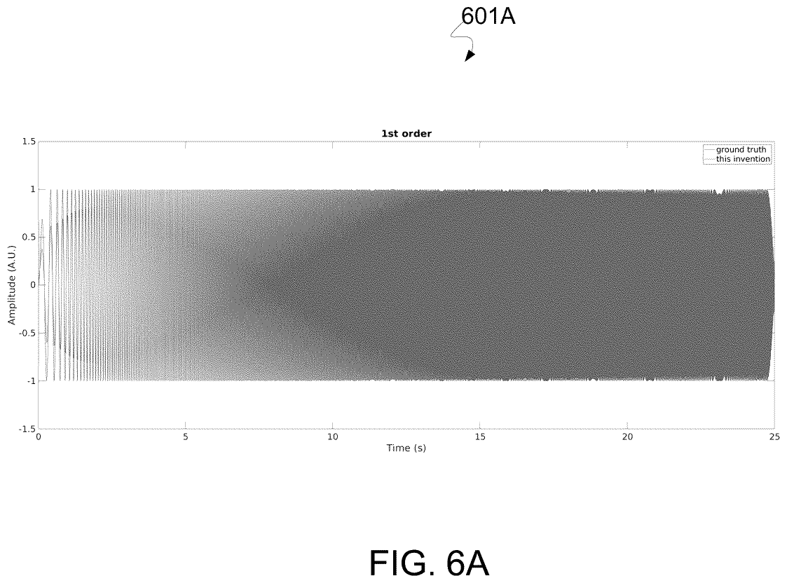

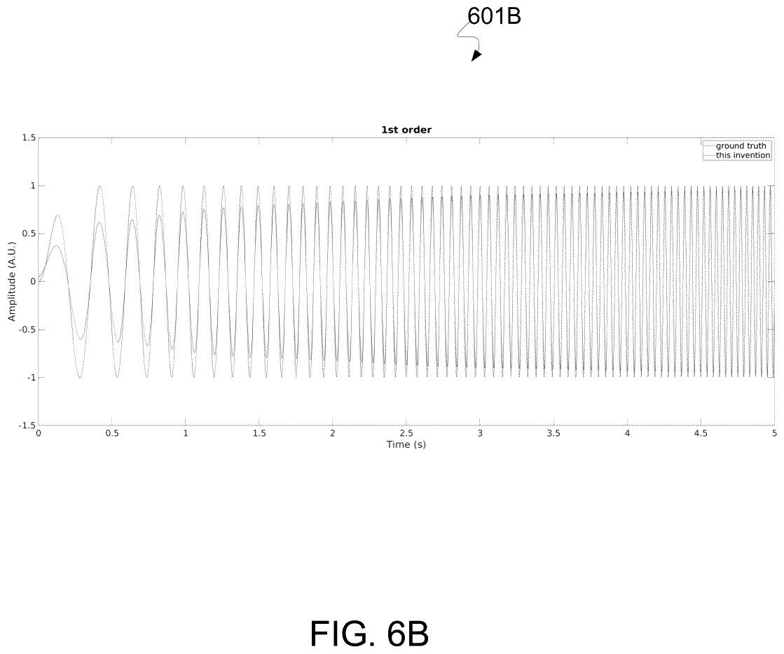

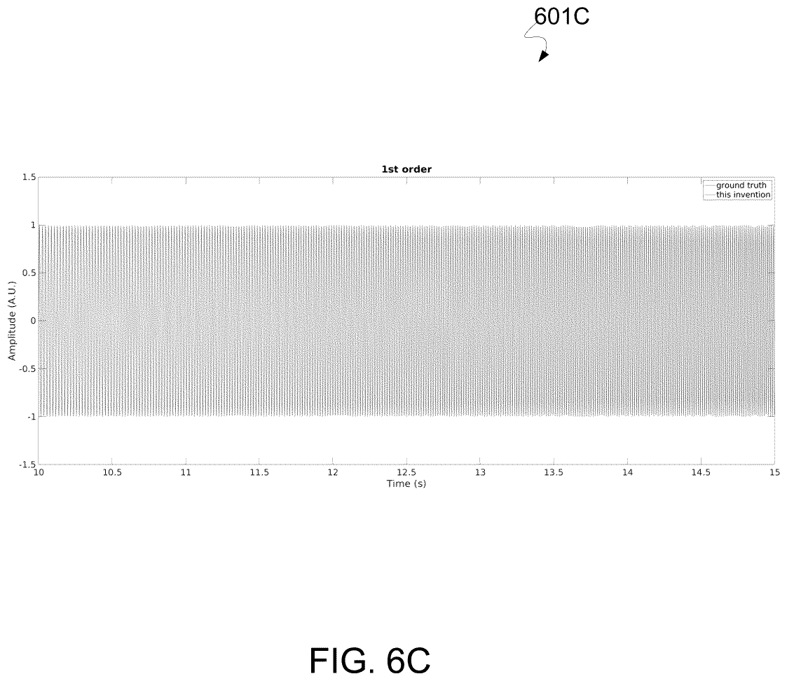

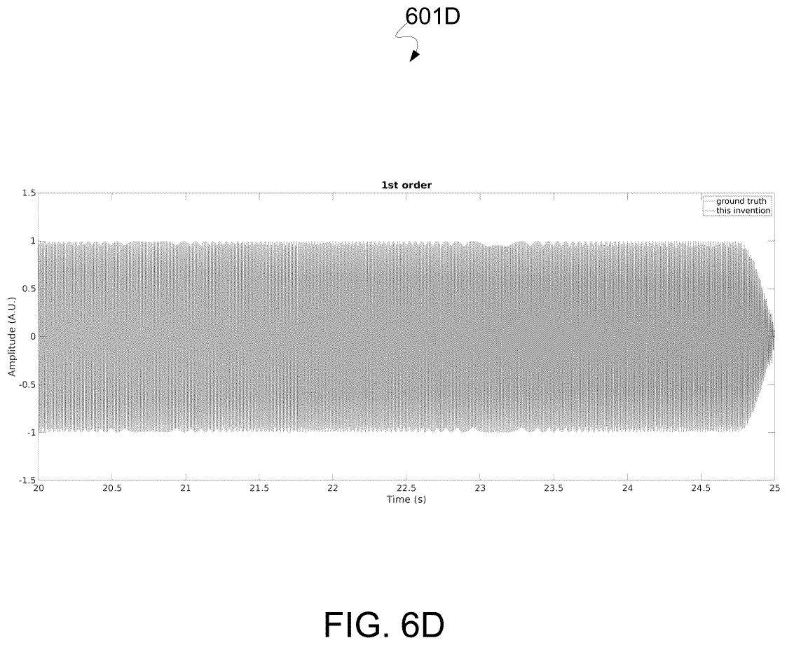

FIGS. 6A to 6D illustrates the comparison between the ground-truth fundamental mode signal and the results of retrieved fundamental mode signal according to some implementations of the present disclosure. Plot 601A shows a comparison between the ground-truth fundamental mode from plot 401C and the retrieved fundamental mode from plot 401D. Plot 601B shows the same comparison between 0s and 5s. Plot 601C shows the same comparison between 10s and 15s. Plot 601D shows the same comparison between 20s and 25s. As revealed by the comparisons, the implementations are capable of retrieving the fundamental mode signal component with high fidelity, while using a compact and well-posed matrix for expedient processing and low bandwidth of memory usage, both of which are well suited for handling large amounts of input streams of data from the field (e.g., petabytes) where harmonics overlap with the fundamental mode due to the frequency sweep in the driving pilot sweep signal.

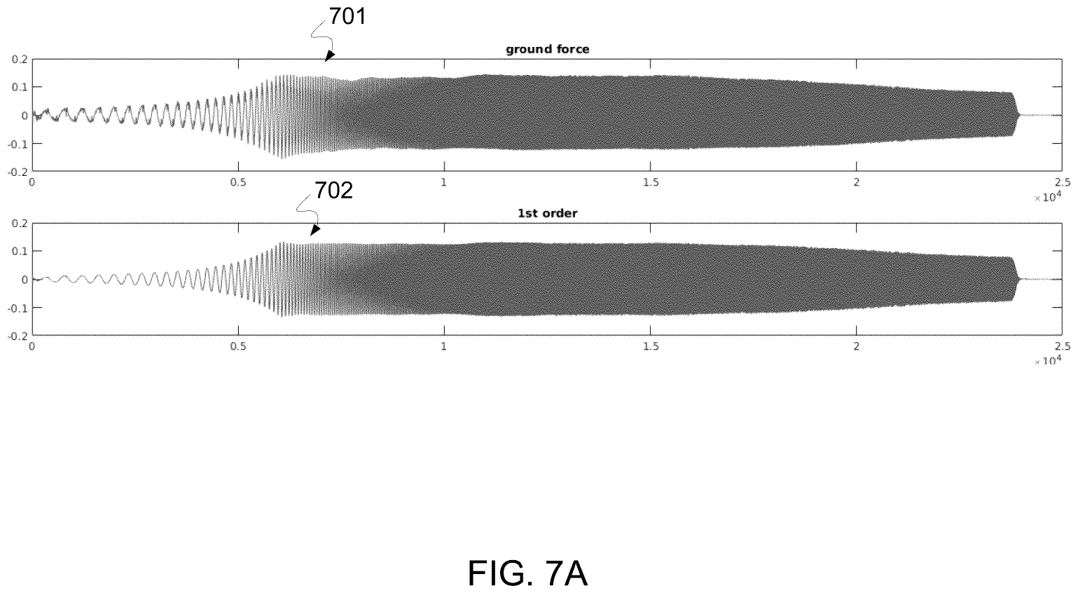

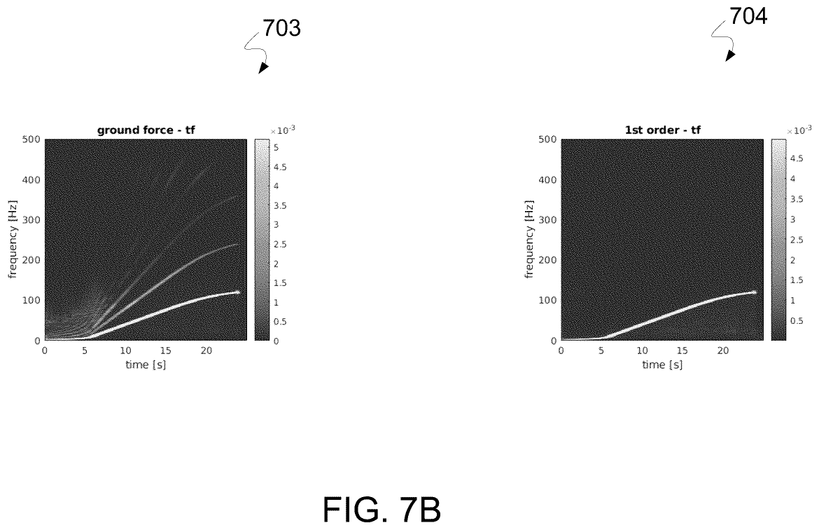

The efficacy of the implementations consistent with the spirits of inventive subject matter have also been demonstrated by field data examples. FIG. 7A illustrates field data ground force signal (701) and the results of retrieved fundamental mode signal (702) according to some implementations of the present disclosure and using other approaches. FIG. 7B shows the respective Gabor domain plots for the signals of FIG. 7A. As shown, the Gabor domain plot of the field-data ground-force signal (703) has the fundamental mode as well as several harmonic modes, all of which exhibits a swept-frequency characteristic. Because these signal components are overlapping due to the sweep, traditional signal processing techniques, such as a low pass filtering, are not practical for handing such data, especially when considering the size of the data (e.g., petabytes). The Gabor domain plot of the retrieved fundamental mode signal (704), however, contains the fundamental mode.

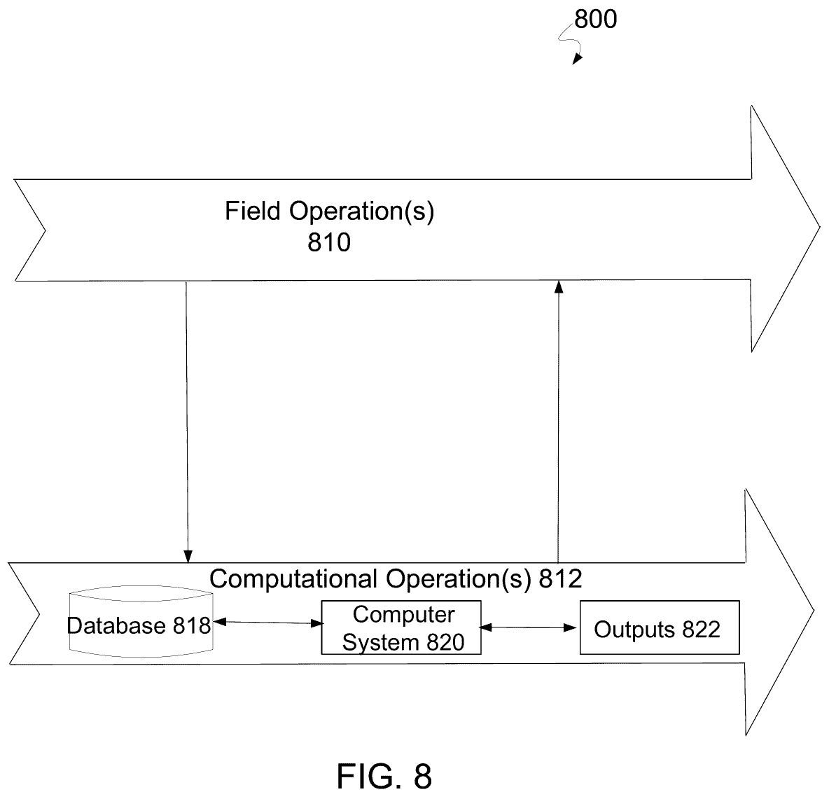

FIG. 8 illustrates hydrocarbon exploration and production operations 800 that include both one or more field operations 810 and one or more computational operations 812, which exchange information and control exploration for the exploration and production of hydrocarbons. In some implementations, outputs of techniques of the present disclosure can be performed before, during, or in combination with the hydrocarbon exploration and production operations 800, specifically, for example, either as field operations 810 or computational operations 812, or both.

Examples of field operations 810 include surveying operations, forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. A more detailed example can be found in FIG. 9. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 9 is a block diagram 900 illustrating an example of a computer system 900 used to provide computational functionalities associated with described algorithms, methods, functions, processes, flows, and procedures, according to an implementation of the present disclosure. The illustrated computer 902 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 902 can comprise a computing device that includes an input device, such as a keypad, keyboard, touch screen, another input device, or a combination of input devices that can accept user information, and an output device that conveys information associated with the operation of the computer 902, including digital data, visual, audio, another type of information, or a combination of types of information, on a graphical-type user interface (UI) (or GUI) or other UI.

The computer 902 can serve in a role in a computer system as a client, network component, a server, a database or another persistency, another role, or a combination of roles for performing the subject matter described in the present disclosure. The illustrated computer 902 is communicably coupled with a network 930. In some implementations, one or more components of the computer 902 can be configured to operate within an environment, including cloud-computing-based, local, global, another environment, or a combination of environments.

The computer 902 is an electronic computing device operable to receive, transmit, process, store, or manage data and information associated with the described subject matter. According to some implementations, the computer 902 can also include or be communicably coupled with a server, including an application server, e-mail server, web server, caching server, streaming data server, another server, or a combination of servers.

The computer 902 can receive requests over network 930 (for example, from a client software application executing on another computer 902) and respond to the received requests by processing the received requests using a software application or a combination of software applications. In addition, requests can also be sent to the computer 902 from internal users, external or third-parties, or other entities, individuals, systems, or computers.

Each of the components of the computer 902 can communicate using a system bus 903. In some implementations, any or all of the components of the computer 902, including hardware, software, or a combination of hardware and software, can interface over the system bus 903 using an application programming interface (API) 912, a service layer 913, or a combination of the API 912 and service layer 913. The API 912 can include specifications for routines, data structures, and object classes. The API 912 can be either computer-language independent or dependent and refer to a complete interface, a single function, or even a set of APIs. The service layer 913 provides software services to the computer 902 or other components (whether illustrated or not) that are communicably coupled to the computer 902. The functionality of the computer 902 can be accessible for all service consumers using this service layer. Software services, such as those provided by the service layer 913, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 902, alternative implementations can illustrate the API 912 or the service layer 913 as stand-alone components in relation to other components of the computer 902 or other components (whether illustrated or not) that are communicably coupled to the computer 902. Moreover, any or all parts of the API 912 or the service layer 913 can be implemented as a child or a sub-module of another software module, enterprise application, or hardware module without departing from the scope of the present disclosure.

The computer 902 includes an interface 904. Although illustrated as a single interface 904 in FIG. 9, two or more interfaces 904 can be used according to particular needs, desires, or particular implementations of the computer 902. The interface 904 is used by the computer 902 for communicating with another computing system (whether illustrated or not) that is communicatively linked to the network 930 in a distributed environment. Generally, the interface 904 is operable to communicate with the network 930 and comprises logic encoded in software, hardware, or a combination of software and hardware. More specifically, the interface 904 can comprise software supporting one or more communication protocols associated with communications such that the network 930 or interface's hardware is operable to communicate physical signals within and outside of the illustrated computer 902.

The computer 902 includes a processor 905. Although illustrated as a single processor 905 in FIG. 9, two or more processors can be used according to particular needs, desires, or particular implementations of the computer 902. Generally, the processor 905 executes instructions and manipulates data to perform the operations of the computer 902 and any algorithms, methods, functions, processes, flows, and procedures as described in the present disclosure.

The computer 902 also includes a database 906 that can hold data for the computer 902, another component communicatively linked to the network 930 (whether illustrated or not), or a combination of the computer 902 and another component. For example, database 906 can be an in-memory, conventional, or another type of database storing data consistent with the present disclosure. In some implementations, database 906 can be a combination of two or more different database types (for example, a hybrid in-memory and conventional database) according to particular needs, desires, or particular implementations of the computer 902 and the described functionality. Although illustrated as a single database 906 in FIG. 9, two or more databases of similar or differing types can be used according to particular needs, desires, or particular implementations of the computer 902 and the described functionality. While database 906 is illustrated as an integral component of the computer 902, in alternative implementations, database 906 can be external to the computer 902. As illustrated, the database 906 holds data 916 including, for example, data encoding the seismic data traced acquired from receivers placed at a geophysical exploration site, as explained in more detail in association with FIGS. 1-6, 7A-7F, 8A-8F, 9A-9F, and 10.

The computer 902 also includes a memory 907 that can hold data for the computer 902, another component or components communicatively linked to the network 930 (whether illustrated or not), or a combination of the computer 902 and another component. Memory 907 can store any data consistent with the present disclosure. In some implementations, memory 907 can be a combination of two or more different types of memory (for example, a combination of semiconductor and magnetic storage) according to particular needs, desires, or particular implementations of the computer 902 and the described functionality. Although illustrated as a single memory 907 in FIG. 9, two or more memories 907 or similar or differing types can be used according to particular needs, desires, or particular implementations of the computer 902 and the described functionality. While memory 907 is illustrated as an integral component of the computer 902, in alternative implementations, memory 907 can be external to the computer 902.

The application 908 is an algorithmic software engine providing functionality according to particular needs, desires, or particular implementations of the computer 902, particularly with respect to functionality described in the present disclosure. For example, application 908 can serve as one or more components, modules, or applications. Further, although illustrated as a single application 908, the application 908 can be implemented as multiple applications 908 on the computer 902. In addition, although illustrated as integral to the computer 902, in alternative implementations, the application 908 can be external to the computer 902.

The computer 902 can also include a power supply 914. The power supply 914 can include a rechargeable or non-rechargeable battery that can be configured to be either user- or non-user-replaceable. In some implementations, the power supply 914 can include power-conversion or management circuits (including recharging, standby, or another power management functionality). In some implementations, the power-supply 914 can include a power plug to allow the computer 902 to be plugged into a wall socket or another power source to, for example, power the computer 902 or recharge a rechargeable battery.

There can be any number of computers 902 associated with, or external to, a computer system containing computer 902, each computer 902 communicating over network 930. Further, the term “client,” “user,” or other appropriate terminology can be used interchangeably, as appropriate, without departing from the scope of the present disclosure. Moreover, the present disclosure contemplates that many users can use one computer 902, or that one user can use multiple computers 902.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
accessing a plurality of seismic signal traces received at receivers in response to a Vibroseis truck, equipped with at least one base plate that is driven by a pilot sweep signal, generating a ground-force signal when the at least one base plate makes ground impact for launching an acoustic wave into a subterranean region of interest at a geophysical exploration site,
wherein the pilot sweep signal is characterized by a sweeping instantaneous frequency including a fundamental frequency, and
wherein the ground-force signal comprises a fundamental mode signal component as well as at least one harmonic mode signal component;
obtaining, using a digital transform, an analytic function representation for the pilot sweep signal and the ground-force signal, wherein the analytic function representation comprises an amplitude portion and a phase portion;
establishing a matrix representation characteristic of the phase portion of the analytic function representation for the fundamental frequency in the sweeping instantaneous frequency of the pilot sweep signal, and wherein the matrix representation is size limited by a sampling limit for the at least one harmonic mode signal component;
retrieving, from the analytic function representation for the ground-force signal and after inverting the matrix representation, the fundamental mode signal component of the ground-force signal; and
providing the retrieved fundamental mode signal component of the ground-force signal for subsequent data processing such that an image of the subterranean region of interest is formed and visualized to facilitate decision making at the geophysical exploration site.

2. The computer-implemented method of claim 1, wherein said matrix representation comprises a Vandermonde matrix.

3. The computer-implemented method of claim 1, wherein the sampling limit for the at least one harmonic mode signal component is a Nyquist limit.

4. The computer-implemented method of claim 3, wherein the matrix representation is size limited by a window that meets the Nyquist limit.

5. The computer-implemented method of claim 4, wherein said retrieving comprises:
applying the inverted matrix representation to a segment of the analytic function representation for the ground-force signal, wherein the segment is size limited by the window.

6. The computer-implemented method of claim 5, wherein said retrieving further comprises:
extracting a real part of results of applying the inverted matrix representation to the segment of the analytic function representation for the ground-force signal.

7. The computer-implemented method of claim 5, wherein each data trace comprises a sequence of sample points providing multiple segments, each size limited by the window, and
wherein a corresponding matrix representation is established for each segment.

8. The computer-implemented method of claim 7, wherein each corresponding matrix representation is inverted for application to the corresponding segment so that the fundamental mode of signal component is retrieved from the sequence of sample points.

9. The computer-implemented method of claim 1, wherein said providing comprises:
cross-correlating the retrieved fundamental mode signal component of the ground-force signal with the seismic signal traces; and
generating a set of seismic data based on results of said cross-correlating so that the image of the subterranean region of interest can be reconstructed using the set of seismic data in response to the acoustic wave.

10. The computer-implemented method of claim 9, further comprising:
identifying, using a seismic interpretation workstation, a drilling target based, at least in part, on the image; and
planning, using a well planning system, a wellbore trajectory guided by the drilling target.

11. A computer system comprising one or more hardware computer processors configured to perform operations of:
accessing a plurality of seismic signal traces received at receivers in response to a Vibroseis truck, equipped with at least one base plate that is driven by a pilot sweep signal, generating a ground-force signal when the at least one base plate makes ground impact for launching an acoustic wave into a subterranean region of interest at a geophysical exploration site,
wherein the pilot sweep signal is characterized by a sweeping instantaneous frequency including a fundamental frequency, and
wherein the ground-force signal trace comprises a fundamental mode signal component as well as at least one harmonic mode signal component;
obtaining, using a digital transform, an analytic function representation for the pilot sweep signal and the ground-force signal, wherein the analytic function representation comprises an amplitude portion and a phase portion;
establishing a matrix representation characteristic of the phase portion of the analytic function representation for the fundamental frequency in the sweeping instantaneous frequency of the pilot sweep signal, and wherein the matrix representation is size limited by a sampling limit for the at least one harmonic mode signal component;
retrieving, from the analytic function representation for the ground-force signal and after inverting the matrix representation, the fundamental mode signal component of the ground-force signal; and
providing the retrieved fundamental mode signal component of the ground-force signal for subsequent data processing such that an image of the subterranean region of interest is formed and visualized to facilitate decision making at the geophysical exploration site.

12. The computer system of claim 11, wherein said matrix representation comprises a Vandermonde matrix.

13. The computer system of claim 11, wherein the sampling limit for the at least one harmonic mode signal component is a Nyquist limit.

14. The computer system of claim 13, wherein the matrix representation is size limited by a window that meets the Nyquist limit.

15. The computer system of claim 14, wherein said retrieving comprises:
applying the inverted matrix representation to a segment of the analytic function representation for the ground-force signal, wherein the segment is size limited by the window.

16. The computer system of claim 15, wherein said retrieving further comprises:
extracting a real part of results of applying the inverted matrix representation to the segment of the analytic function representation for the ground-force signal.

17. The computer system of claim 15, wherein each data trace comprises a sequence of sample points providing multiple segments, each size limited by the window, and
wherein a corresponding matrix representation is established for each segment.

18. The computer system of claim 17, wherein each corresponding matrix representation is inverted for application to the corresponding segment so that the fundamental mode of signal component is retrieved from the sequence of sample points.

19. The computer system of claim 11, wherein said providing comprises:
cross-correlating the retrieved fundamental mode signal component of the ground-force signal with the seismic signal traces;
generating a set of seismic data based on results of said cross-correlating so that the image of the subterranean region of interest can be reconstructed using the set of seismic data in response to the acoustic wave.

20. The computer system of claim 19, further comprising a seismic interpretation workstation configured to:
identify a drilling target based, at least in part, on the image; and
generate a plan, using a well planning system, a wellbore trajectory guided by the drilling target.
